(19) United States
(12) Patent Application Publication
(10) Pub. No.: US 2004/0091583 A1
(43) Pub. Date: May 13, 2004

(54) Confection enclosure and ring

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Clyde I. Coughenour, 16607 Sutton Place, Woodbridge, VA, 22191, US

(21) Appl. No.: 10/400,515

(22) Filed: Mar. 28, 2003

Related U.S. Application Data
(63) Continuation-in-part of application No. 10/288,923, filed on Nov. 7, 2002.

(51) Int. Cl. C12C 1/027

(52) U.S. Cl. 426/106

(57) ABSTRACT

A portable confection container housing is provided with two open ends and one or two lids and ring(s) for transport. The lid(s) and housing confine one or more confection flavors accessible from the two open housing ends. A diaphragm can separate the two flavors with one flavor confection provided with an access opening through which a handle can pass and be removably secured to the diaphragm.

This application is a Continuation-in-Part of applicants' previously filed application Ser. No. 10/288,923, filed 07 Nov. 2002, entitled Confection Enclosure and Ring, now

### BACKGROUND OF THE INVENTION

1. Field of the Invention

Two different flavor confections are provided in a housing having two open ends with one or both ends having a lid with a ring for transport and a handle can be attached to a diaphragm separating the different flavor confections.

2. Description of Related Art

The consumption of hard and semi-solid confections has been common for many years. The confections are typically protected by a paper or foil wrapper, whether on a stick or not. In many instances, and particularly so when consumed by children, the entire confection is not consumed or is dropped and contaminated when not completely consumed, the confection is either unnecessarily thrown away or wrapped in the same or a new paper or foil for storage. The wrapping of a partially consumed confection typically results in the sticky surface of the confection tightly sticking to the wrapper. It is difficult to remove such a wrapper. During consumption, the sticky confection will smudge and soil any surface it contacts and will usually become contaminated by any surface contacted.

The combination of rings and other articles and confections is old. W. Parker, U.S. Des No. 229,522, issued 11 Dec. 1973, makes a ring of candy. A. Shorin et al, U.S. Des No. 242,645 and U.S. Des No. 242,646, issued 7 Dec. 1976, teach a ring having a matrix for supporting candy and a ring with candy respectively. S. Coleman, U.S. Pat. No. 219,445, issued 9 Sep. 1879, teaches a ring having a spring-loaded closure for a compartment for housing matches supported on a ring. C. Bull, U.S. Pat. No. 5,732,862, issued 31 Mar. 1998, teaches a ring that removably supports a container for holding dental materials.

### SUMMARY OF THE INVENTION

A confection is housed within a covered container having a lid for preventing contamination of the confection. The housing or lid is provided with a ring for slipping over a finger for convenience and transport. The lid can be removed from the container, part of the confection consumed, and the lid reapplied for transport, storage, and contamination free later consumption. The housing can have both ends open and contain different confection within the housing on either end.

### BRIEF DESCRIPTION OF THE DRAWINGS

FIGS. 1 and 2 are exploded side views of the confection containing ring with the lid shown separated.

FIG. 3 is an exploded side view of a second embodiment of the confection containing ring with the ring supporting confection separated from the cover.

FIG. 4 is an exploded side view of a third embodiment of the confection containing ring with the confection containing housing separated from the ringed lid.

FIG. 5 is a partial sectional view of a lid and housing attachment.

FIG. 6 is an exploded side view of the confection containing housing and lid with ring separated.

FIG. 7 is an exploded side view of the confection containing housing having two lids and rings separated.

FIG. 8 is a side view of the confection containing housing having the two lids and rings attached.

FIG. 9 is an exploded side view of the confection container housing and the lid with ring separated and housing provided with a handle.

### DESCRIPTION OF THE PREFERRED EMBODIMENTS

The present confection housing ring is for conveniently transporting protecting and consuming the confection. The ring can be secured to the lid or housing. The confection can easily be placed on a finger and carried around until it is desired to consume the confection. The confection is consumed by simply separating the lid from the housing and licking the confection. Any remaining confection can be kept safe and free from contamination until it is desired to consume more of it by simply joining the lid and housing.

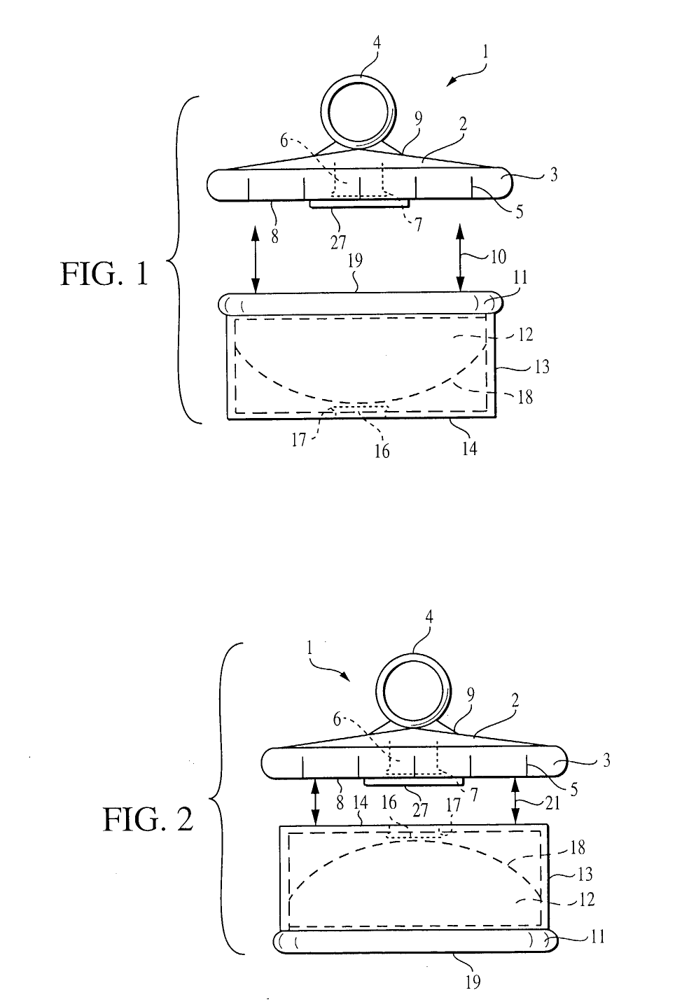

Vertically the confection housing ring 1 of FIG. 1 shows the lid 2 separated from the housing 13. The lid has a ring 4 secured to the top or outer end of the lid and an arcuate rim 3 around the base of or inner end of the lid. The arcuate rim is provided with slits 5 around its length to provide lines of weakness so that the arcuate rim can be sprung outwardly when pressure is applied. A protrusion 6 is provided centrally under or within the lid with a lip 7 around its terminal end. The housing 13 provides an arcuate base 18 within the housing for supporting the confection 12. The inner end 19 of the housing is provided with an arcuate rim 11 that is slightly smaller than the arcuate rim 3 of the lid. The outer end 14 of the housing has a centrally positioned recess 16 with a groove 17 around its terminal end. In its on finger portable configuration, the base 8 of the lid 2 is pressed 10 onto the housing inner end 19 where the arcuate rim 3 of the lid snaps over the arcuate rim 11 of the housing 13 where it seals the lid to the housing where it remains until use.

To consume the confection 12, the lid 2 is pulled away 10 from the housing. The slits 5 in the arcuate non-resilient rim 3 act as lines of weakness and give the arcuate rim 3 a spring like quality enabling the rim 3 to be removed from the slightly smaller arcuate rim 11. With the lid removed from the housing 13, the confection 12 can be licked and consumed by extending the tongue through the open housing inner end 19. The protrusion 6 within the lid 2 can be pressed 21 into the recess 16 in the housing as indicated in FIG. 2. The outer end 14 of the housing fits within the arcuate rim 3, and the inner end 8 of the lid. The lip 7 on the protrusion 6 slips into the groove 17 at the base of the recess 16 to removably secure the lid 2 to the housing outer end 14. With the lid secured to the housing outer end, the confection is exposed through the housing open inner end 19 while the confection housing ring is positioned on a finger. After the consumer is finished, the remaining confection can again be sealed by pulling 21 the lid protrusion 6 from the housing outer end recess 16 and pressing the lid arcuate rim 3 over the housing arcuate rim 11.

The inner end 8 of the lid 2 is provided with indicia such as a hologram or graphic image 27 so that the lid can be used as an aesthetic ring independent of the housing when the confection is consumed as well as a means for housing other objects with use of the empty housing 13 attached to the lid.

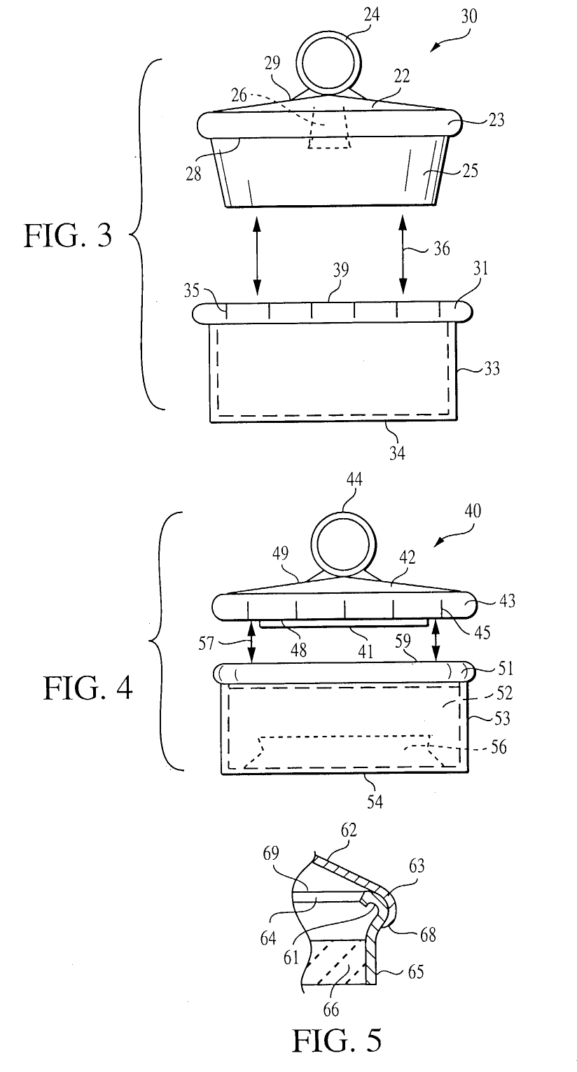

FIG. 3 is a modification of the confection containing ring of FIGS. 1 and 2. The lid 22 has a ring 24 on its outer end 29 and an arcuate rim 23, similar to that of FIGS. 1 and 2, on its inner end 28, except that the rim 23 does not have slits. The confection 25 is held under the lid 22 using a matrix 26 to secure it in place. The confection extends beyond the lid base 28. The housing 33 is hollow for receiving the confection 25 for storage and transport. The housing inner end 39 has an arcuate rim 31 provided with slits 35. The arcuate rim 23 of the lid is slightly smaller than the arcuate rim 31 of the housing. By pressing 36 the lid and housing together, the arcuate rim 31 of the housing snaps over the arcuate rim 23 of the lid for sealing, transport and/or storage. By pulling 36 the lid 22 and housing 33 apart, the confection is exposed for consumption. The confection can be consumed while the lid is held on a finger by the ring 24, without the necessity to remove the ring from the finger used for transport.

FIG. 4 is a further modification of the confection containing ring of FIGS. 1 and 2. The lid 42 has ring 44 secured to the top or outer end 49 of the lid with an arcuate rim 43 having slits 45 on its inner end 48 as in FIGS. 1 and 2. The housing 53 contains the confection 52 being held within the housing by matrix 56 on the inner side of the outer end 54 of the housing. The inner end of the housing 59 is provided with an arcuate rim 51 that is slightly smaller than the lid arcuate rim 43. By pressing 57 the lid 42 against the housing 53, the housing arcuate rim 51 and the lid arcuate rim 43 snap together to seal and secure the two together. By pulling 57 the lid and housing apart, the two are separated. The confection 52 can then be consumed by licking the confection through the open housing inner end 59. After a consumption of some of the confection, the remaining portion can be sealed within the housing by pressing 57 the lid back onto the housing. The lid inner end 48 is provided with indicia such as a hologram or graphic image 41 so the lid can be worn as an aesthetic ring independent of the housing.

The horizontal shape of the lid and housing is optional. They can be circular, oval or have flat sides that match. The housing and or lid can be constructed of metal or plastic. They are preferably large enough to avoid accidental swallowing. FIG. 5 is a partial sectional view of a slit arcuate rim 63 inner end 68 held in place over an arcuate rim 61 for holding and sealing one component 62, for example a lid, onto a second component 65, for example a housing. The connection seals and protects any confection held between the two. Any confection 66 within the housing 65 is exposed through the opening 64 at the housing inner end 69.

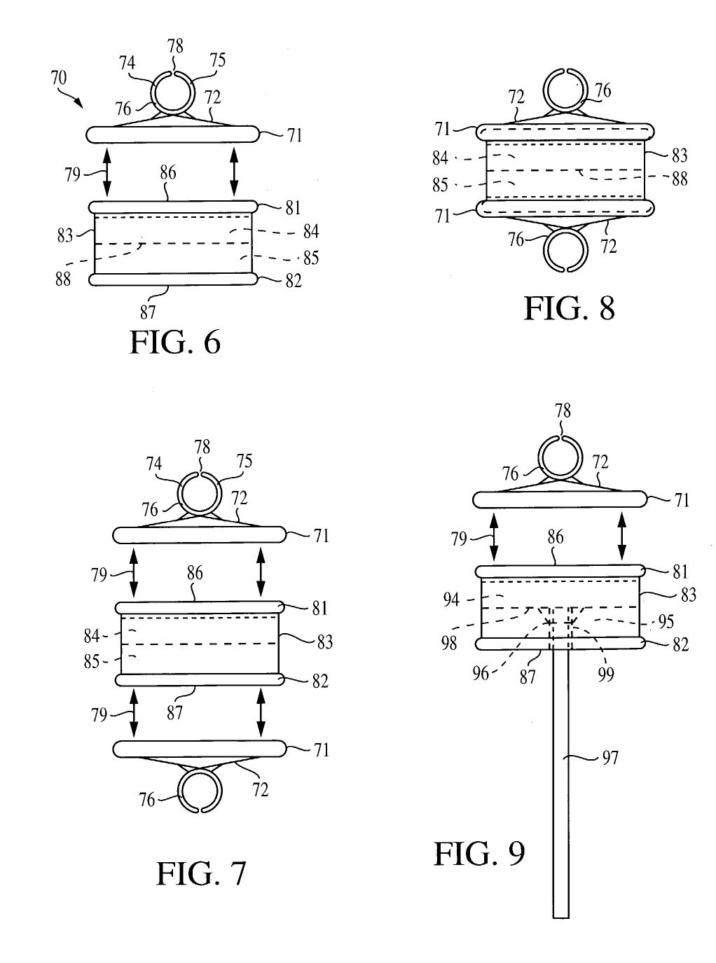

FIG. 6 has a lid 72 housing 83 combination 70. The lid is provided with a rim 71 having resilience provided by the plastic it is manufactured from. The lid rim has enough inherent resilience to preclude the need for slits. A ring 76 is a part of or attached to the lid 72. The ring 76 has a separation 78 that divides the ring to provide two arms 74,75 and the ring is made from a resilient plastic or metal so that the arms can separate to fit different size fingers. The lid can be removably 79 secured to the housing 83 that contains the confection.

The housing 83 is provided with an arcuate rim 81,82 on both open ends 86,87. One or more flavors can be provided. The open end 86 of the housing can contain a confection 84 with the second open end left empty 85 or two different flavor confections 84,85 can each be accessible from one of the respective open ends. The confections can be filled to occupy a desired volume of the housing such as ½, or the housing can be provided with a separation diaphragm 88. The lid 72 can be secured to either end 86,87 of the housing 83 by securing the rim 71 of the lid 72 over one of the rims 81,82 of the confection housing 83. The housing can then be transported by placing the ring 76 over a finger.

FIGS. 7 and 8 are similar to FIG. 6 and are provided with the same components with the addition of a second lid 72. The second lid is provided so that both open ends of the housing 83 can be covered or exposed as desired 79. The housing 83 in FIG. 7 is shown with both lids 72 separated to expose both openings 86,87 of the housing. The housing shown in FIG. 8 has both lids secured to the housing so that both openings are sealed by the lids.

The embodiment of FIG. 9 is similar to that shown in FIG. 6 with a lid 72 and ring 76 provided for sealing an open end 86 of the housing 83 containing a first confection 94. The embodiment of FIG. 9 differs from that shown in FIG. 6 in that a rigid diaphragm 98 is provided for removably retaining a handle 97 that can be used to hold the housing to control it during consumption of the first confection 94. The handle 97 can be removably secured to the diaphragm 98, for example, by a threaded nut 96 centrally located and integral with or attached to the diaphragm. The second open end 87 of the housing can be left empty or can be provided with a second confection 95 for consumption with the handle 97 removed. An access opening 99 can be provided through the second confection for accessing the handle to the securing threaded nut 96.

It is believed that the construction, operation and advantages of this invention will be apparent to those skilled in the art. It is to be understood that the present disclosure is illustrative only and that changes, variations, substitutions, modifications and equivalents will be readily apparent to one skilled in the art and that such may be made without departing from the spirit of the invention as defined by the following claims.

1. A confection housing ring comprising:
a first lid having an outer end and an inner end;
a housing having a first open end and a second open end;
said lid inner end having a means for attachment to said housing first open end and second open end;
confection housed within said housing and said confection being accessible from said housing first open end and second open end;
a first ring attached to said first lid outer end for supporting said first lid and said housing on a finger.

2. A confection housing ring as in claim 1 wherein:
said first ring has two arms with each arm having an inner end and an outer end;
said first ring inner ends are secured to said lid.

3. A confection housing ring as in claim 2 wherein:
said first ring arms are resilient and said first ring outer ends are separated to fit different size fingers.

4. A confection housing ring as in claim 1 wherein:
said confection housed within said housing includes two different flavors with one flavor accessible from said first housing open end and a second flavor accessible from said second housing open end.

5. A confection housing ring as in claim 4 wherein:
said confection one flavor is separated from said confection second flavor by a diaphragm that extends between said two flavor confections.

6. A confection housing ring as in claim 1 wherein:
said first lid inner end attachment means is a rim that engages a rim attaching means on said housing.

7. A confection housing ring as in claim 6 wherein:
said first lid inner end rim is resilient for passing over said rim on said housing.

8. A confection housing ring as in claim 6 wherein:
said first ring has two arms with each arm having an inner end and an outer end;
said first ring inner ends are secured to said lid.
said first ring arms are resilient and said first ring outer ends are separated to fit different size fingers.

9. A confection housing ring as in claim 5 wherein:
said first ring has two arms with each arm having an inner end and an outer end;
said first ring inner ends are secured to said lid.
said first ring arms are resilient and said first ring outer ends are separated to fit different size fingers.

10. A confection housing ring as in claim 9 wherein:
said first lid inner end attachment means is a rim that engages a rim attaching means on said housing.
said first lid inner end rim is resilient for passing over said rim on said housing.

11. A confection housing ring as in claim 1 including:
a second lid having an outer end and an inner end with said inner end having a means for attaching said second lid to said housing first open end and second open end;
said second lid outer end having a ring for attachment to a finger.

12. A confection housing ring as in claim 11 wherein:
said second ring has two arms with each arm having an inner end and an outer end;
said second ring inner ends are secured to said lid.
said second ring arms are resilient and said second ring outer ends are separated to fit different size fingers.

13. A confection housing ring as in claim 11 wherein:
said second lid inner end attachment means is a rim that engages a rim attaching means on said housing.
said second lid inner end rim is resilient for passing over said rim on said housing.

14. A confection housing and ring including:
a first lid having an outer end and an inner end;
a housing having a first open end and a second open end;
said lid inner end having a means for attachment to said housing first open end and second open end;
confection housed within said housing and being accessible through said housing first open end;
a diaphragm within said housing;
a handle attached to said diaphragm and extending through said housing second open end.

15. A confection housing and ring as in claim 14 wherein:
said diaphragm is provided with a threaded means for removably securing said handle to said diaphragm.

16. A confection housing and ring as in claim 14 wherein:
said confection housed within said housing includes two different flavors with one flavor accessible from said first housing open end and a second flavor accessible from said second housing open end.

17. A confection housing and ring as in claim 16 wherein:
said confection one flavor is separated from said confection second flavor by said diaphragm that extends between said two flavor confections.

18. A confection housing and ring as in claim 17 wherein:
said second flavor being accessible from said housing second open end has an access opening for passage of said handle.

19. A confection housing and ring as in claim 18 wherein:
said first ring has two arms with each arm having an inner end and an outer end;
said first ring inner ends are secured to said lid.
said first ring arms are resilient and said first ring outer ends are separated to fit different size fingers.

20. A confection housing and ring as in claim 14 wherein:
said first lid inner end attachment means is a rim that engages a rim attaching means on said housing.
said first lid inner end rim is resilient for passing over said rim on said housing.
